(19) United States
(12) Patent Application Publication
(10) Pub. No.: US 2007/0158625 A1
(43) Pub. Date: Jul. 12, 2007

(54) Scorch prevention in flexible polyurethane foams

(76) Inventors: Samuel Bron, Rehovot (IL); Ariel Sluszny, Kiryat Ata (IL); Dorit Peled, Haifa (IL); Dorit Perle, Haifa (IL)

Correspondence Address: Kevin D. McCarthy;Roach Brown McCarthy & Grober, P.C., 1620 Liberty Bldg., 420 Main St., Buffalo, NY, 14202, US

(21) Appl. No.: 11/628,999

(22) Filed: Dec. 8, 2006

(30) Foreign Application Priority Data
Jun. 10, 2004 (IL) 162450
May 30, 2005 (IL) PCT/IL05/00554

(51) Int. Cl. C09K 21/00

(52) U.S. Cl. 252/601; 521/82

(57) ABSTRACT

An anti-scorch composition for flame-retarded flexible polyurethane foams, comprising, in combination, one or more antioxidant agents, together with one or more salt(s) of an organic acid.

### FIELD OF THE INVENTION

The present invention relates to the prevention of discoloration in flexible polyurethane foams, a phenomenon commonly referred to as “scorching”. More particularly, the invention relates to novel compositions useful to alleviate or prevent the aforementioned undesirable effect.

### BACKGROUND OF THE INVENTION

Scorching is an undesirable discoloration phenomenon which occurs within the foam blocks, causing them to assume a yellow to brown color. This discoloration is especially apparent in the center of the blocks where the internal temperatures remain high for a relatively long period of time. The exposure of the interior of the foams to high temperatures leads to embrittlement and the core discoloration commonly known as scorching. In extreme cases this can result in ignition of the foam buns, sometimes with disastrous consequences. In some severe cases, it can cause a degradation of physical properties or, where scorching is particularly intense, can result in spontaneous combustion of freshly made foam blocks. Flame retardants, with few exceptions, e.g., pentabromodiphenyl oxide, exacerbate the “scorch” problems that arise during processing of low density foams.

It is known that the use of flame retardants (FR) in polyols can lead to even higher discoloration in polyurethane (PU) foams than the non-FR grades. Flame retardants, with few exceptions, create two major problems for the manufacturers of water-blown, flexible, slab stock foam. They increase the “scorch” problems that arise during processing of low density foams and they increase the smoldering tendency of foams subjected to the California TB 117 standard.

The flame-retardant tribromoneopentyl alcohol (known as FR-5 13 ex Dead Sea Bromine Group (DSBG)) was investigated as flame retardant in PU foams already in 1975 [J. H. Botkin, Scorch Inhibitors for Polyurethane Slabstock Foams, Adv. Urethane Sci. Technol., vol. 14, pp. 57-80, 1998].

The use of antioxidants has been proposed in the art and it can mitigate to some extent the increased scorch and discoloration in flame retarded polyols and foams. However, the literature consulted, and experiments carried out, by the inventors indicate that antioxidants by themselves are not very efficient in preventing scorch when halogen containing flame retardants are present in the formulation. Thus, the art has so far failed to provide an efficient solution to the problem of scorch taking place during the manufacturing of flexible polyurethane foams.

It is an object of the present invention to provide an anti-scorch composition that efficiently addresses the problem of scorch for flexible polyurethane formulations flame retarded with halogen-containing flame retardants.

It is another object of the invention to provide an anti-scorch combination that overcomes the drawbacks of the prior art.

It is yet another object of the invention to provide a method for preventing or diminishing the occurrence of scorch during the manufacturing of flexible polyurethane foams.

Other purposes and advantages of the invention will become apparent as the description proceeds.

### SUMMARY OF THE INVENTION

The invention is directed to an anti-scorch composition for flame-retarded flexible polyurethane foams, comprising, in combination, one or more antioxidant agents, together with one or more salt(s) of an organic acid.

According to a preferred embodiment of the invention the organic acid is selected from among saturated or unsaturated, aliphatic or aromatic mono- or di-carboxylated acids. According to another preferred embodiment of the invention the salt of the organic acid is a salt of Ca, Zn, Ba or Sn.

Illustrative and non-limitative examples of antioxidant agents are phenols and amino oxygen scavengers, such as hindered phenols.

Illustrative and non-limitative examples of amino oxygen scavengers include alkylated diphenylamines.

According to a preferred embodiment of the invention the flame-retardant is a halogen-containing flame retardant, such as—but not limited to—tribromoneopentyl alcohol.

According to a further preferred embodiment of the invention the composition further comprises an epoxy compound, such as—but not limited to—diglycidyl ether of bisphenol A and its derivatives.

In another aspect the invention is directed to a method for preventing or diminishing scorch in flame-retarded flexible polyurethane foams, comprising adding to the polyurethane composition, prior to foaming, one or more antioxidant agents, together with one or more salt(s) of an organic acid, as hereinbefore defined.

The above and other objects and advantages of the invention will be better understood from the following illustrative and non-limitative examples.

Test Procedures:

### MW Test Protocol for Scorch Evaluation

The test method consists of the following steps:

1. Foam production in a small shoe box with a square cross-section.

2. Immediately after the foam rise is complete (usually less than 2 minutes), the foam is heated using a microwave (MW) oven using a predetermined time and power level.

3. The foam is then heated in an oven at 120±2° C. for 2 min.

4. The foam is allowed to cure at RT (room temperature) for an additional 15 min.

5. By the end of the RT-curing time the foam is cut and the scorch is observed.

### Scorch Evaluation

The scorch is evaluated using two methods:

1. The foam is photographed using a digital camera. This allows for a visual comparison between the scorch of a reference formulation and the scorch of the formulation under investigation.

2. The foam color is analyzed using a spectrophotometer. The results are expressed in the usual color space: L*a*b and performed accordingly to ASTM D-2244.

Note: the scorch intensity may change from day to day according to the physical conditions of the surroundings in which the foam has been prepared (usually the temperature and relative humidity). This is why it is customary to prepare each day a reference sample.

### EXAMPLES

### Foam Preparation

The mixture was prepared in a 0.65 1 disposable cup. The components were added one at a time starting with the polyol. The mixture was vigorously mixed at 3500 rpm for 10 seconds following the addition of each component, not including the toluene diisocyanate (TDI). After the addition of TDI, the mixture was mixed for an additional 10 sec and then poured into a 25×25×17 cm cardboard box. The times between the TDI addition and the pouring into the cardboard box and the end of the foam blowing (rise time) were monitored.

### Comparative Samples and Results

The effect of the antiscorching ingredients and their combinations was measured on the darkest areas on the foam after microwave oven treatment, using a spectrophotometer which provides color measurements expressed in the L*a*b color space. The most relevant color parameters for scorch assessment are Δb and ΔE.

The color parameters are given as normalized values relative to the reference specimens. As explained in the MW oven procedure, this particular method for scorch propensity assessment requires that a new reference foam be prepared, subjected to MW oven procedure and measured in each and every day of measurements. This requirement is related to the effect various experimental conditions, such as the temperature and the relative humidity of the air in the lab may have on the level of scorch. The normalized Δb and ΔE differences between the reference foam (containing no antiscorching ingredients) and foams containing various ingredients with antiscorch effects, are calculated as follows:

$$ΔΔ b ( normalized ) = \frac{Δ b ( reference ) - Δ b ( sample )}{Δ b ( reference )} \cdot 100$$

$$ΔΔ E ( normalized ) = \frac{Δ E ( reference ) - Δ E ( sample )}{Δ E ( reference )} \cdot 100$$

Note: a value greater than 100 can sometimes emerge from these calculations since both Δb and ΔE for each specimen are compared to a factory white standard. The higher the ΔΔb and ΔΔE values, the lower the scorch.

Formulations for two grades of foams are shown in Tables I and II: Medium density foams (Table I) have a density of approximately 25 kg/m³; Low density foams (Table II) have a density of approximately 15 kg/m³.

Ingredients: AO1 and AO5 are antioxidants produced by Goldschmidt (Degussa) and contain combinations of hindered phenols and aromatic diamines.

Epoxy 828 is Diglycidyl ether of bisphenol A (DGEBA).

ESBO=Epoxidized Soya Bean Oil.

All other ingredients below the FR-513 line in the table are metallic salts (Ca, Zn, Ba, Ti) of organic acids.

TABLE I
Normal density foams

| Ingredient | 1 | 2 | 3 | 4 | 5 | 6 | 7 | 8 | 9 |
|---|---|---|---|---|---|---|---|---|---|
| Polyol | 100 | 100 | 100 | 100 | 100 | 100 | 100 | 100 | 100 |
| Water | 4.2 | 4.2 | 4.2 | 4.2 | 4.2 | 4.2 | 4.2 | 4.2 | 4.2 |
| Silicon 8228 | 1.1 | 1.1 | 1.1 | 1.1 | 1.1 | 1.1 | 1.1 | 1.1 | 1.1 |
| Amine Dabco 33LV | 0.09 | 0.09 | 0.09 | 0.09 | 0.09 | 0.09 | 0.09 | 0.09 | 0.09 |
| Amine BDE | 0.03 | 0.03 | 0.03 | 0.03 | 0.03 | 0.03 | 0.03 | 0.03 | 0.03 |
| Tin T-9 | 0.25 | 0.25 | 0.25 | 0.25 | 0.25 | 0.25 | 0.25 | 0.25 | 0.25 |
| Toluene di-isocyanate | 56.31 | 56.31 | 56.31 | 56.31 | 56.31 | 56.31 | 56.31 | 56.31 | 56.31 |
| (TDI) | | | | | | | | | |
| FR-513 | 5 | 5 | 5 | 5 | 5 | 5 | 5 | 5 | 5 |
| AO5 | 0.42 | 0.21 | 0.85 | | | | | | |
| Calcium stearate | 0.42 | 0.21 | | | | | | | |
| (CaSt) | | | | | | | | | |
| PK4610 | 0.42 | 0.21 | | | | | | | |
| Epoxy 828 | | | 0.85 | | 0.1 | 0.1 | 0.21 | | |
| ESBO | | | | 1.7 | | | | | |
| LZB 138 | | | | | 0.21 | | | 0.21 | 0.21 |
| AO 1 | | | | | 0.21 | 0.21 | 0.21 | 0.21 | 0.21 |
| CZ400 | | | | | | 0.21 | | 0.21 | |
| CZ 118 S | | | | | | | 0.21 | | 0.21 |
| ΔΔb | 90.13 | 106.1 | 49.17 | −132.6 | 82.32 | 77.06 | 93.93 | 84.58 | 102.9 |
| ΔΔE | 17.04 | 10.84 | 18.34 | −99.43 | 27.61 | 32.67 | 30.14 | 37.42 | 33.98 |

TABLE II
Low density foams

| Ingredient | 1 | 2 | 3 | 4 | 5 | 6 |
|---|---|---|---|---|---|---|
| Polyol | 100 | 100 | 100 | 100 | 100 | 100 |
| Water | 5.25 | 5.25 | 5.25 | 5.25 | 5.25 | 5.25 |
| Silicon 8228 | 1.0 | 1.0 | 1.0 | 1.0 | 1.0 | 1.0 |
| Amine Dabco 33LV | 0.06 | 0.06 | 0.06 | 0.06 | 0.06 | 0.06 |
| Amine BDE | 0.046 | 0.046 | 0.046 | 0.046 | 0.046 | 0.046 |
| Tin T-9 | 0.37 | 0.37 | 0.37 | 0.37 | 0.37 | 0.37 |
| Methylene Chloride | 11 | 11 | 11 | 11 | 11 | 11 |
| (MeCl) | | | | | | |
| TDI | 71.1 | 71.1 | 71.1 | 71.1 | 71.1 | 71.1 |
| FR-513 | 15 | 15 | 15 | 15 | 15 | 15 |
| AO5 | | | 0.1 | 0.3 | | 0.2 |
| Epoxy 828 | 0.5 | 1.0 | | | | |
| BM270 | | | | | 1.0 | 0.2 |
| LZB287 | | | | | | 0.6 |
| ΔΔb | −14.11 | 24.37 | −15.10 | −77.1 | 95.29 | 50.90 |
| ΔΔE | 0 | 13.73 | −10.13 | −41.03 | 27.80 | 11.70 |

From the results in Tables I and II it is clearly seen that the compositions of the invention attain a substantial improvement.

The notations and composition of materials used as antiscorch ingredients in the examples in Tables I and II are detailed in Table III.

TABLE III
Composition of ingredients used as antiscorch materials

| Producer | Name | Ingredients | | State |
|---|---|---|---|---|
| Akcros | Lankromark LZB287 | Barium oleate | 40% | Liquid |
| | | arium t-butylbenzoate | | |
| | | 2) Zinc 2-ethylhexanoate | 5-10% | |
| | | 3) Phosphite esters | 20-40% | |
| | | 4) 2-(2-butoxyethoxy)ethanol | 5-10% | |
| | | 5) Phenol | 5-10% | |
| | Lankromark LZB413 | Barium 2-ethylhexanoate | 20% | Liquid |
| | | Barium oleate | | |
| | | Barium t-butylbenzoate | | |
| | | 2) Zinc 2-ethylhexanoate | 1-5% | |
| | | 3) Zinc t-butylbenzanoate | 1-5% | |
| | | 4) Phosphite esters | 20-40% | |
| | | 5) Trisnonylphenyl phosphite | 1-5% | |
| | | 6) 2-(2-butoxyethoxy ethanol) | | |
| | Lankromark LZB138 | 1) Barium compounds | 2-15% | Liquid |
| | | (% as barium metal) | | |
| | | 2) Phenol | 1-5% | |
| | Lankroflex E2307 | 1) Epoxidised soya bean oil | >99% | Liquid |
| | Tinstab BTS71S | 1) n-Butyltin tris(2- | ˜20% | Liquid |
| | | ethylhexylthio-glycolate) | | |
| | | 2) Di-n-butyltin bis(2- | ˜70% | |
| | | ethylhexylthio-glycolate) | | |
| | Tinstab BM270 | Di-n-butyltin bis(methyl- | ˜95% | Liquid |
| | | maleate) | | |
| Shell | Epoxy 828 | | ˜100% | Liquid |
| Goldschmidt | Ortegol AO1 | Steric hindered phenol derivate | 66.7% | |
| | | Alkylated diphenylamine | 33.3% | |
| | Ortegol AO5 | Steric hindered phenol derivate | 70-72% | |
| | | Alkylated diphenylamine | 20-22% | |
| | Mark CZ 400 (Ca/Zn | 2-(2-Butoxyethoxy)ethanol | <10% | Liquid |
| | stabilizer) | Alkylarylphosphites | 55-65% | |
| | | Calcium 4-(1,1- | <10% | |
| | | dimethylethyl)benzoate | | |
| Crompton | Mark CZ 118S (Ca/Zn | Tris(nonylphenyl)phosphite | 30-40% | Liquid |
| | stabilizer) | Other components - not listed | | |
| | Mark BZ 592 (Ba/Zn | Solvent naphta, light aromatic | <10% | Liquid |
| | stabilizer) | Barium compounds | 35-45% | |
| | | Triisodecyl phosphite | <25% | |
| | Mark BZ 562 (Ba/Zn | Solvent naphta, light aromatic | <10% | Liquid |
| | stabilizer) | Alkylarylphosphites | 20-30% | |
| | | Zinc bis(p-nonylphenolate) | <3% | |
| | | Barium compounds | 35-45% | |
| | Mark BZ 555 (Ba/Zn | Tris(2-ethylhexylmercaptoace- | 5-15% | Liquid |
| | stabilizer) | tate)phosphate | | |
| | | Diisodecyl phenyl phosphite | 25-35% | |
| | | Solvent naphta, light aromatic | 5-15% | |
| | | Barium compounds | 20-30% | |
| | Mark BZ 563 (Ba/Zn | Diisodecyl phenyl phosphite | 30-50% | Liquid |
| | stabilizer) | 2-(2-Butoxyethoxy)ethanol | <5% | |
| | | Zinc bis(p-nonylphenolate) | <5% | |
| | | Barium compounds | 20-30% | |

Example 3 in Table I and Examples 3 and 4 in Table II, respectively, demonstrate that the use of a conventional antioxidant, i.e. a mixture of hindered phenols and alkylated diphenyldiamines, alone or together with an epoxy moiety, does not prevent scorch in a bromine-containing FR formulation. Epoxy alone, either as DGEBA or ESBO, are not effective either (Examples 4 in Table 1, and Examples 1 and 2 in Table II). However, addition of metallic salts of various organic acids, significantly improves the resistance to scorch of a polyurethane flexible foam formulation including a bromine-containing flame retardant (Examples 8, 9 - Table I, and Examples 5, 6 - Table II).

All the above description has been provided for the purpose of illustration, and is not intended to limit the invention in any way. Various modifications can be carried out in the method and system according to the invention, without departing from its spirit.

1. An anti-scorch composition for flame-retarded flexible polyurethane foams, comprising, in combination, one or more antioxidant agents, together with one or more salt(s) of an organic acid.

2. A composition according to claim 1, wherein the organic acid is selected from among saturated or unsaturated, aliphatic or aromatic mono- or di-carboxylated acids.

3. A composition according to claim 2, wherein the salt of the organic acid is a salt of Ca, Zn, Ba or Sn.

4. A composition according to claim 1, wherein the antioxidant agent(s) is selected from among phenols and amino oxygen scavengers.

5. A composition according to claim 4, wherein the phenol is a hindered phenol.

6. A composition according to claim 4, wherein the amino oxygen scavenger is an alkylated diphenylamine.

7. A composition according to claim 1, wherein the flame-retardant is a halogen-containing flame retardant.

8. A composition according to claim 7, wherein the flame-retardant is tribromoneopentyl alcohol.

9. A composition according to claim 1, further comprising an epoxy compound.

10. A composition according to claim 9, wherein the epoxy compound is selected from among diglycidyl ether of bisphenol A and its derivatives.

11. A method for preventing or diminishing scorch in a flame-retarded flexible polyurethane foam, comprising adding to the polyurethane composition, prior to foaming, one or more antioxidant agents, together with one or more salt(s) of an organic acid.

12. A method according to claim 11, wherein the organic acid is selected from among saturated or unsaturated, aliphatic or aromatic mono- or di-carboxylated acids.

13. A method according to claim 12, wherein the salt of the organic acid is a salt of Ca, Zn, Ba or Sn.

14. A method according to claim 11, wherein the antioxidant agent(s) is selected from among phenols and amino oxygen scavengers.

15. A method according to claim 14, wherein the phenol is a hindered phenol.

16. A method according to claim 14, wherein the amino oxygen scavenger is an alkylated diphenylamine.

17. A method according to claim 11, wherein the flame-retardant is a halogen-containing flame retardant.

18. A method according to claim 17, wherein the flame-retardant is tribromoneopentyl alcohol.

19. A method according to claim 11, further comprising adding an epoxy compound.

20. A method according to claim 19, wherein the epoxy compound is selected from among diglycidyl ether of bisphenol A and its derivatives.
